(19) United States
(12) Patent Application Publication
(10) Pub. No.: US 2015/0047026 A1
(43) Pub. Date: Feb. 12, 2015

(54) ANOMALY DETECTION TO IDENTIFY COORDINATED GROUP ATTACKS IN COMPUTER NETWORKS

(71) Applicant: LOS ALAMOS NATIONAL SECURITY, LLC, Los Alamos, NM (US)

(72) Inventors: Joshua Charles Neil, Jemez Springs, NM (US); Melissa Turcotte, London (GB); Nicholas Andrew Heard, Kent (GB)

(73) Assignee: Los Alamos National Security, LLC, Los Alamos, NM (US)

(21) Appl. No.: 14/383,024

(22) PCT Filed: Mar. 14, 2013
(86) PCT No.: PCT/US13/31463

§ 371 Date: Sep. 4, 2014

Related U.S. Application Data
(60) Provisional application No. 61/614,118, filed on Mar. 22, 2012.

(51) Int. Cl. H04L 29/06

(52) U.S. Cl. CPC H04L 63/1425
USPC 726/22

(57) ABSTRACT

Systems, apparatuses, methods, and computer programs for detecting anomalies to identify coordinated group attacks on computer networks are provided. An anomaly graph of a network including nodes, edges, and an indegree of the nodes in the anomaly graph may be determined. Nodes with an indegree of at least two may be designated as potential targets. Nodes with no incoming connections may be designated as potentially compromised nodes. The designated potentially compromised nodes may be outputted as potentially associated with a coordinated attack on the network when the potentially compromised nodes connect to one or more of the same potential target nodes.

### CROSS REFERENCE TO RELATED APPLICATIONS

This application claims the benefit of U.S. Provisional Application Ser. No. 61/614,148, filed on Mar. 22, 2012. The subject matter of this earlier filed provisional patent application is hereby incorporated by reference in its entirety.

### STATEMENT OF FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### FIELD

The present invention generally relates to detecting network anomalies, and, more particularly, to detecting anomalies that are indicative of coordinated group attacks on computer networks.

### BACKGROUND

Detecting attacks by multiple attackers, whether human or automated systems (e.g., botnets) is of increasing importance in interest in computer security. For example, some approaches have attempted to detect botnets by using methods based on clustering computers over time that share similar characteristics in their communication and activity traffic. These methods monitor network traffic on the edge of a network, looking for hosts within the network that share similar connections to external Internet Protocol (“IP”) addresses, rather than monitoring the internal network traffic. For the types of attacks these methods aim to detect, the various compromised hosts in the network aren't necessarily controlled by a central entity.

Another conventional intrusion detection system aims to detect large-scale malicious attacks on computer networks by constructing graphs of network activity over time based on a user specified rule set. Presenting graphs of these network events is believed to enable the analyst to visually determine if suspicious network activity is taking place. However, what would be considered as anomalous is left to the user, and there is no suggestion of looking for overlapping activity within a network as a measure of a coordinated attack occurring.

A significant area of research in intrusion detection is that of alert correlation, which involves clustering alerts generated by multiple intrusion detection systems. Statistical tests are used to assess correlation of the alerts based on their similarities and proximities in time. The aim is to reduce false positives and aid the analyst by attributing multiple alerts to a single threat, giving a more clear view of the different stages of an attack and reducing the amount of alerts the analyst has to sift through. However, such an approach does not specifically look for overlap in connectivity.

Detecting coordinated attacks on a much wider scale on online platforms, such as distributed denial-of service attacks or large-scale stealthy scans, is another major area of research. Collaborative intrusion detection systems aim to detect these coordinated attacks by using alert correlation as described above on alerts generated by intrusion detection systems across a range of networks. However, methods that address coordinated attacks on internal networks have not been addressed. Accordingly, an approach that identifies coordinated attacks on internal networks may be beneficial.

### SUMMARY

Certain embodiments of the present invention may provide solutions to the problems and needs in the art that have not yet been fully identified, appreciated, or solved by current network anomaly detection systems. For example, some embodiments of the present invention detect anomalies to identify coordinated group attacks on internal computer networks

In an embodiment, a computer-implemented method includes determining, by a computing system, an anomaly graph of a network including nodes, edges, and an indegree of the nodes in the anomaly graph. The computer-implemented method also includes designating, by the computing system, nodes with an indegree of at least two as potential targets and designating, by the computing system, nodes with no incoming connections as potentially compromised nodes. The computer-implemented method further includes outputting, by the computing system, the designated potentially compromised nodes as potentially associated with a coordinated attack on the network when the potentially compromised nodes connect to one or more of the same potential target nodes.

In another embodiment, an apparatus includes at least one processor and memory including instructions. The instructions, when executed by the at least one processor, are configured to cause the at least one processor to monitor a network over time periods to determine anomalous behavior signifying potential activity from a group of attackers during at least one time period. The instructions are also configured to cause the at least one processor to provide an indication that a potential group attack is occurring in the network when anomalous behavior is determined during at least one time period.

In yet another embodiment, a system includes memory storing computer program instructions configured to detect anomalies in a network and a plurality of processing cores configured to execute the stored computer program instructions. The plurality of processing cores is configured to generate an anomaly graph for a network during a time period. The processing cores are also configured to determine whether multiple nodes with no indegree and common node connections exist during the time period. The processing cores are further configured to generate an indication of a potential group attack on the network when the system determines that multiple nodes with no indegree and common node connections exist in one or more subgraphs of the anomaly graph.

### BRIEF DESCRIPTION OF THE DRAWINGS

For a proper understanding of the invention, reference should be made to the accompanying figures. These figures depict only some embodiments of the invention and are not limiting of the scope of the invention. Regarding the figures:

FIG. 1A is a subgraph of a set of nodes Sₜ displaying potentially anomalous behavior, according to an embodiment of the present invention.

FIG. 1B is an anomaly subgraph S̅ₜ that has been reduced to nodes displaying group activity, according to an embodiment of the present invention.

FIG. 2 is a flowchart illustrating a method for detecting anomalies to identify coordinated group attacks on a network, according to an embodiment of the present invention.

FIG. 3 is a flowchart illustrating a method for detecting anomalies to identify coordinated group attacks on a network, according to an embodiment of the present invention.

FIG. 4 is a flowchart illustrating a method for detecting anomalies to identify coordinated group attacks on a network, according to an embodiment of the present invention.

FIG. 5 is a block diagram of a computing system for detecting group attacks on a network, according to an embodiment of the present invention.

### DETAILED DESCRIPTION OF THE EMBODIMENTS

Some embodiments of the present invention detect statistical anomalies from multiple, usually coordinated attackers (i.e., teams) in an internal computer network. In certain embodiments, the detection may be performed in real time. Such embodiments consider the problem of anomaly detection on an internal computer network where an anomaly signifies an attack on the network. In particular, the aim of some embodiments is to use an anomaly-based detection system to detect coordinated attacks where an intruder compromises several hosts in the network and simultaneously uses these hosts to conduct targeted malicious activity.

The team aspect of some embodiments is highly novel. Sophisticated adversaries normally use teams of simultaneous attackers to accomplish the mission quickly, particularly in the case of state actors. However, this leads to a larger signal, statistically speaking, since anomalous behavior tends to be more prevalent when multiple attackers are present. Therefore, some embodiments take the simultaneous nature into account, producing better detection performance than considering each anomaly independently.

To enable deployment on large networks, some embodiments initially treat all nodes and edges in the network graph as independent entities and look for potentially anomalous edges over time for significant overlapping or correlated behavior signifying group activity. An example of such group activity could be compromised nodes all connecting with a common set of nodes within some specified time period. Behavior may be classified as anomalous based on some deviation from historical behavior learned using baseline statistical probability models, such as the models discussed in priority U.S. Provisional Patent Application Ser. No. 61/614,148 (hereinafter “the priority application”). The validity of this independence assumption relies on learning the seasonal behavior of each node from the historical data, which informs the baseline probability model. Next, for those periods in which a node is active, the connections along the edges emanating from that node are also treated as being conditionally independent. Together, these two aspects provide a probability model for the activity levels along each edge in the network.

This aggregation of anomalous edges may be a similar idea to the methodology of some implementations in the priority application, which may look for anomalous edges within a network that form a path, with the aim of detecting traversal of an attacker. However, rather than looking for traversal through the network initiating from a single compromised node, some embodiments aim to detect overlap in connections from multiple compromised nodes. Intruders tend to create new behavioral patterns due to the nature of their operations within the network, as well as the fact that they generally do not have access to historical data.

Identification of hackers once they have penetrated the perimeter defenses is paramount in defending government and corporate networks. Rapidly identifying teams of attackers before they can penetrate core network assets can mean millions of dollars in savings for the attacked institution. If the attackers are allowed to persist in a network, penetrating the core machines, the only solution is typically to shut the network down for days, if not weeks. This has obvious implications, from eliminating the functionality of the network to causing significant public relations damage. Per the above, some embodiments of the present invention monitor internal networks to detect teams of hackers. This beneficial feature is not possible with, nor recognized by, conventional systems.

Statistical anomaly detection in some embodiments involves monitoring behavior along each edge (or at least multiple edges) in the network and looking for outlying behavior with respect to a fitted probability model. While an edge continues to behave normally, the data observed may be used to further refine the probability model in a coherent updating scheme. Otherwise, edges can be flagged as anomalous if their current behavior deviates significantly from past behavior. At each point in time, a p-value from the probability model can be obtained for the current behavior along each edge to quantify the current level of deviation. A low p-value may be indicative of potentially anomalous behavior.

A novel aspect of some embodiments is to search within the seemingly anomalous edges over some window of time for significant overlapping or correlated behavior, signifying group activity. An example of such group activity may be compromised nodes all connecting with a common set of nodes within some specified time period. The deviation from normal behavior in observing substantially overlapping anomalous behavior is not captured by the statistically independent probability models, and, thus, this can be seen as additional, relevant information that should be processed within an anomaly detection system.

Aggregating of anomalous edges to detect overlap is a similar idea to the methodology of some implementations discussed in the priority application, which may look for anomalous edges within a network that form a path, with the aim of detecting traversal of an attacker. However, in some embodiments of the present invention, rather than looking for traversal through the network initiating from a single compromised node, overlap in connections from several compromised nodes is detected. A brief example of how overlapping activity can be detected follows.

Recent behavior in the network may be considered to include all connection events during a sliding time window. The width of this window w can be chosen to suit the concerns of the analyst. However, since the embodiment discussed in this example is directed to detecting coordinated activity, w should be small relative to the entire history of the graph.

At time t, let (Vₜ, Eₜ) be the current graph consisting of all communicating nodes Vₜ and all edges Eₜ active during the most recent time window (t−w, t). For each edge (i,j)εEₜ, a p-value p_{ij,t} is obtained, signifying how far the edge has deviated from its usual behavior. For a p-value threshold Tε(0,1), an anomaly graph of the network Sₜ=(Vₜ^{s}, Eₜ^{s}) is formed from edges that have a positive p-value below the threshold:

Eₜ^{s}={(i,j)εEₜ|p_{ij,t}<T} (1)

Vₜ^{s}={iεVₜ|∃j≠iεVₜs.t.(i,j)εEₜ^{s} or (j,i)εEₜ^{s}} (2)

In equation (2), “s.t.” stands for “such that”. In practice, the threshold T can be chosen such that, over a training period, the average anomaly graph size {|Eₜ^{s}|} does not exceed a desired number.

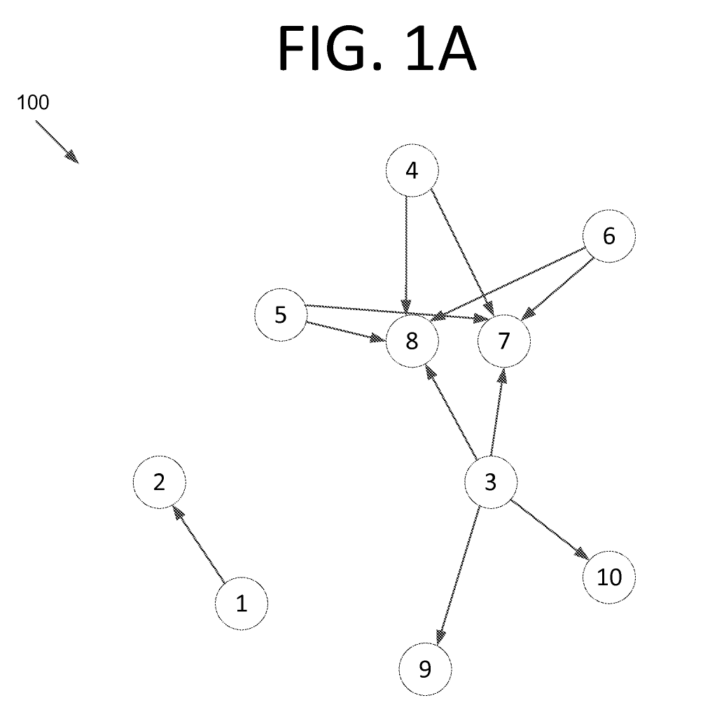

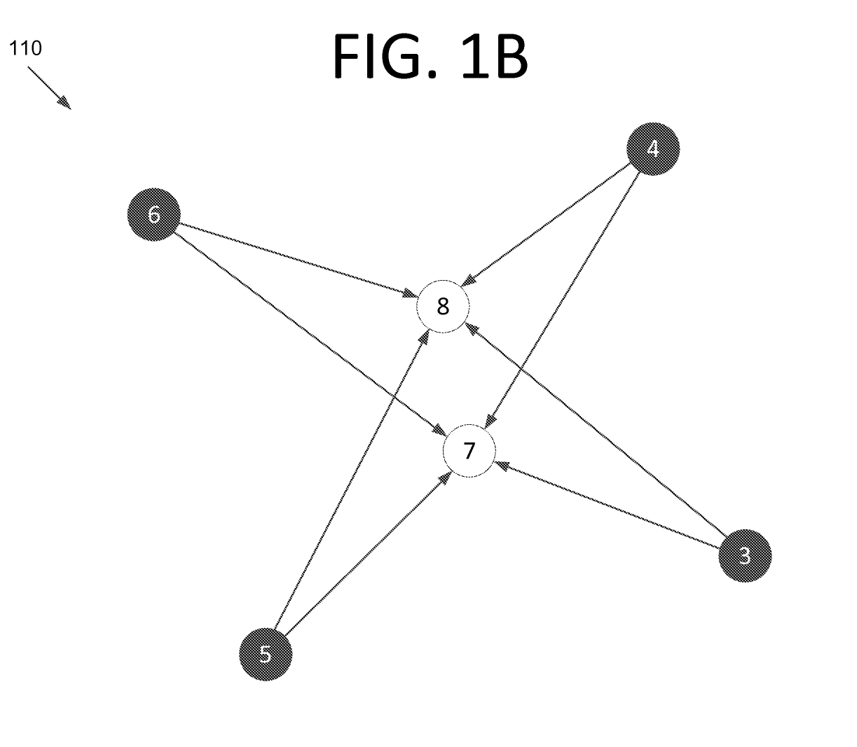

To remove potentially spurious edges, the anomaly graph can be further reduced by deleting all edges that connect to a node with an indegree of one. An example is shown in FIGS. 1A and 1B. This example focuses on graphs of structures that display group behavior. In FIG. 1A, subgraph 100 shows a set of nodes Sₜ displaying potentially anomalous behavior. In FIG. 1B, anomaly subgraph S̅ₜ 110 has been reduced to nodes displaying group activity. It should be noted that each subgraph may represent a group attack, and multiple anomaly subgraphs may be produced in a given time period, or time window, if multiple potential group attacks are detected. Nodes with zero indegree, that is, nodes that receive no incoming connections, are shaded and can be considered as suspected compromised nodes (see FIG. 1B). Nodes with an indegree of two or more can be considered to be the targets (for instance, nodes 7 and 8 in FIGS. 1A and 1B). It should be noted that a node can fall into both categories, and not all nodes without incoming connections are compromised.

A weakly connected subgraph (i.e., component) of a graph is a maximal subgraph with the property that if all directed edges were replaced with undirected edges, the resulting subgraph would be connected. Each of the weakly connected subgraphs of Sₜ can be considered as potentially anomalous, and therefore potentially part of a coordinated attack.

A summary statistic Oₖ can be calculated for each weakly connected subgraph Aₖ=(Vₖ,Eₖ) of a graph to describe the level of overlap. An appropriate choice of the summary statistic might vary according to the nature of the attacks being sought. However, one such statistic that may be considered is the number of undirected edges in the subgraph:

Oₖ=Σ_{i<j}max{ [symbol] (eᵢⱼεEₖ), [symbol] (eⱼᵢεEₖ)} (3)

For simplicity, the observed overlap statistics may be assumed to be independently and identically distributed from some common, but unknown, distribution. An empirical distribution calculated from observed values of the statistic during a training period can provide a nonparametric estimate of this unknown, and potentially complex, distribution.

Returning to evaluation of the network at time t, p-values with respect to this empirical distribution may be obtained for each of the weakly connected subgraphs of the reduced anomaly graph S̅ₜ to provide a measure of anomalousness in the level of overlap in the more anomalous behavior in the network.

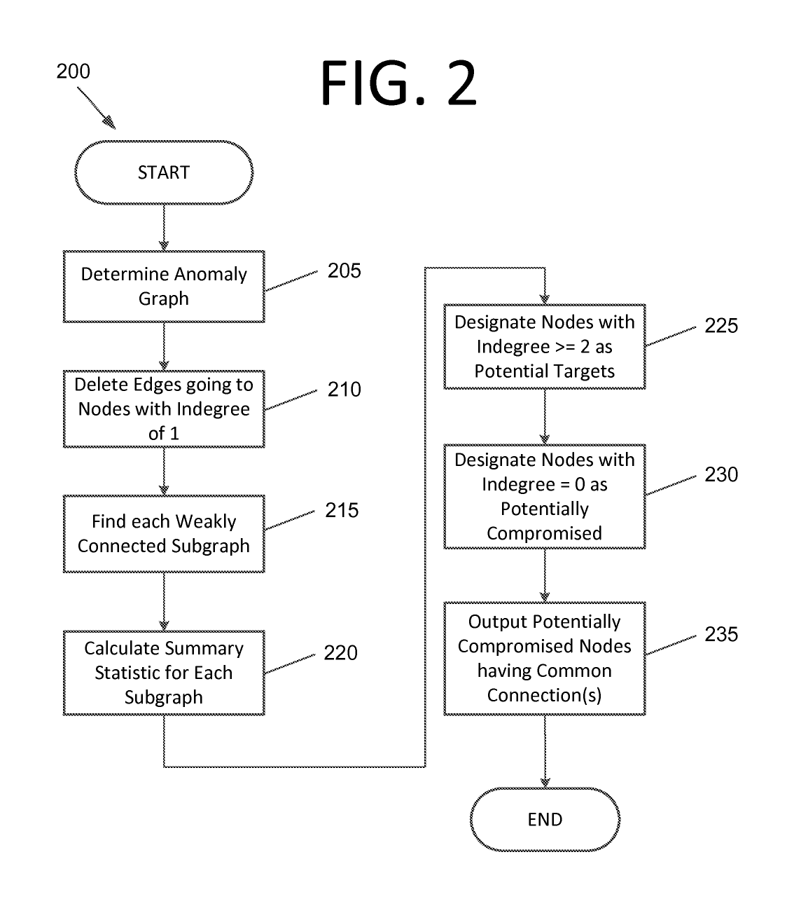

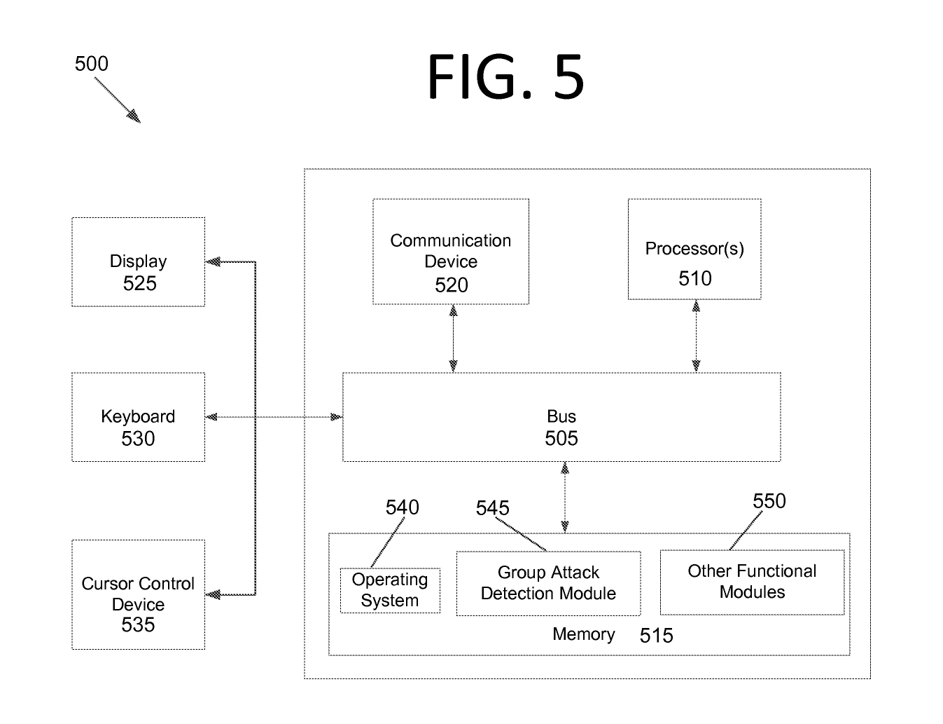

FIG. 2 is a flowchart 200 illustrating a method for detecting anomalies to identify coordinated group attacks on a network, according to an embodiment of the present invention. In some embodiments, the method of FIG. 2 may be performed, for example, by computing system 500 of FIG. 5. The method begins with determining an anomaly graph of a network at 205. The anomaly graph may include nodes, edges, and an indegree of the nodes in the anomaly graph. Next, incoming edges going to nodes with an indegree of one are deleted from the anomaly graph at 210.

Each weakly connected subgraph within the anomaly graph is found at 215. A summary statistic is calculated for each subgraph at 220 to describe the level of overlap. Nodes with an indegree of two or more are designated as potential targets at 225. Nodes with no incoming connections are designated as potentially compromised nodes at 230. The designated potentially compromised nodes are then output as potentially being part of a coordinated attack on the network at 235 when the potentially compromised nodes connect to one or more of the same potential target nodes.

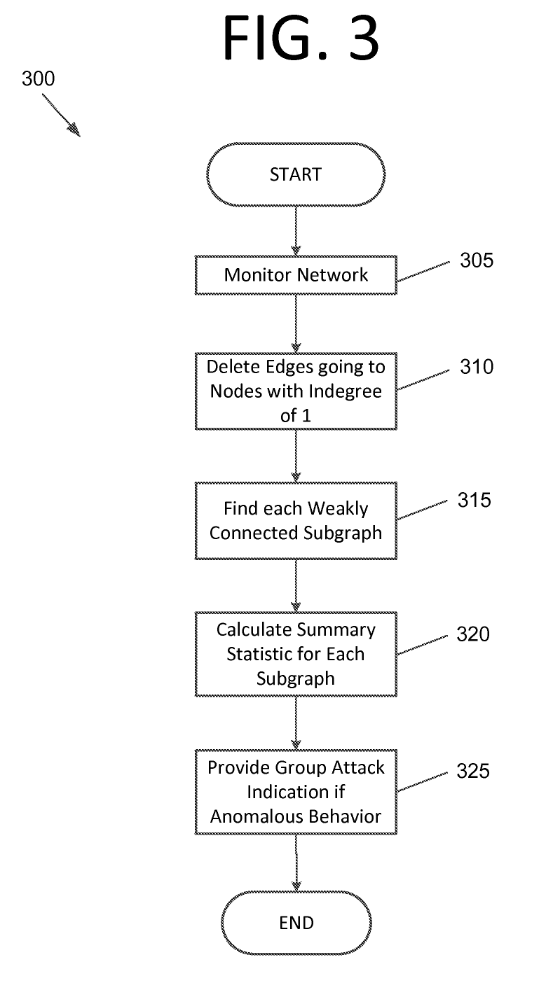

FIG. 3 is a flowchart illustrating a method for detecting anomalies to identify coordinated group attacks on a network, according to an embodiment of the present invention. In some embodiments, the method of FIG. 3 may be performed, for example, by computing system 500 of FIG. 5. The method begins with monitoring a network over time periods at 305 to determine anomalous behavior signifying potential activity from a group of attackers during at least one time period. The anomalous behavior may include overlapping or correlated behavior where a group of potentially compromised nodes attempt to connect to common nodes during at least one of the time periods. A p-value may be determined for each edge in the network in an anomaly graph. The p-value indicates how far a respective edge has deviated from its normal behavior. The anomaly graph may be formed based on the p-values and a p-value threshold.

Incoming edges going to nodes with an indegree of one are deleted from the anomaly graph at 310. Each weakly connected subgraph within the anomaly graph is found at 315. A summary statistic is calculated for each subgraph at 320 using the number of undirected edges in the given subgraph. An indication that a group attack may be occurring in the network is then provided at 325 when anomalous behavior is determined during at least one of the time period.

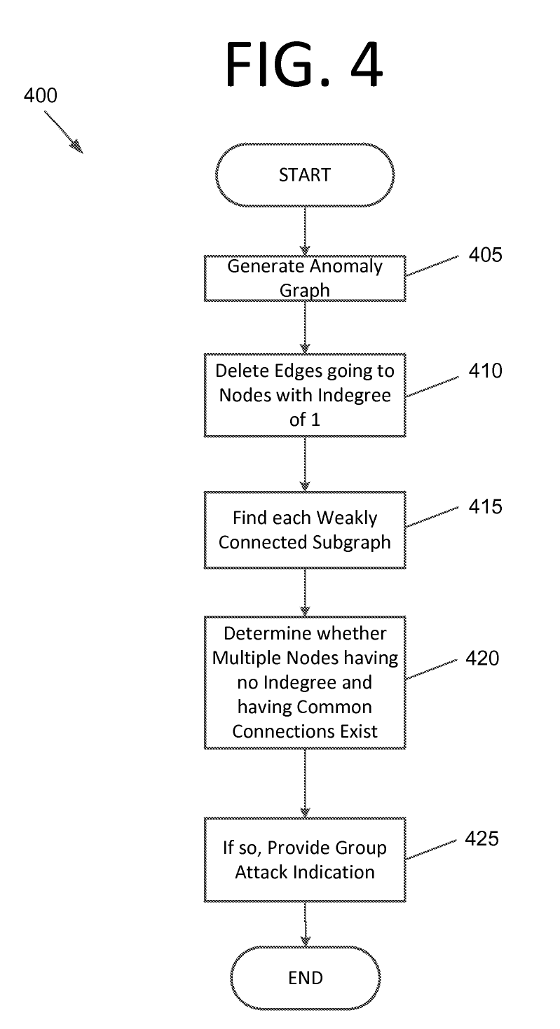

FIG. 4 is a flowchart illustrating a method for detecting anomalies to identify coordinated group attacks on a network, according to an embodiment of the present invention. In some embodiments, the method of FIG. 4 may be performed, for example, by computing system 500 of FIG. 5. The method begins with generating an anomaly graph for a network during a time period at 405. A p-value may be determined for each edge in the anomaly graph. The p-value indicates how far a respective edge has deviated from its normal behavior. The anomaly graph may be formed based on the p-values and a p-value threshold. Incoming edges going to nodes with an indegree of one are deleted from the anomaly graph at 410. Each weakly connected subgraph within the anomaly graph is found at 415.

It is determined whether multiple nodes with no indegree and common node connections exist during the time period at 420. If so, an indication of a potential group attack on the network is generated at 425. The indication may include potentially compromised nodes having no indegree and common node connnections, and potential target nodes with an indegree of two or more to which the potentially compromised nodes are connected.

FIG. 5 is a block diagram of a computing system 500 for detecting group attacks on a network, according to an embodiment of the present invention. Computing system 500 includes a bus 505 or other communication mechanism for communicating information, and processor(s) 510 coupled to bus 505 for processing information. Processor(s) 510 may be any type of general or specific purpose processor, including a central processing unit (“CPU”) or application specific integrated circuit (“ASIC”). Processor(s) 510 may also have multiple processing cores, and at least some of the cores may be configured to perform specific functions. Computing system 500 further includes a memory 515 for storing information and instructions to be executed by processor(s) 510. Memory 515 can be comprised of any combination of random access memory (“RAM”), read only memory (“ROM”), flash memory, cache, static storage such as a magnetic or optical disk, or any other types of non-transitory computer-readable media or combinations thereof. Additionally, computing system 500 includes a communication device 520, such as a transceiver, to wirelessly provide access to a communications network.

Non-transitory computer-readable media may be any available media that can be accessed by processor(s) 510 and may include both volatile and non-volatile media, removable and non-removable media, and communication media. Communication media may include computer-readable instructions, data structures, program modules or other data in a modulated data signal such as a carrier wave or other transport mechanism and includes any information delivery media.

Processor(s) 510 are further coupled via bus 505 to a display 525, such as a Liquid Crystal Display (“LCD”), for displaying information to a user. A keyboard 530 and a cursor control device 535, such as a computer mouse, are further coupled to bus 505 to enable a user to interface with computing system 500. However, in certain embodiments such as those for mobile computing implementations, a physical keyboard and mouse may not be present, and the user may interact with the device solely through display 525 and/or a touchpad (not shown). Any type and combination of input devices may be used as a matter of design choice.

In one embodiment, memory 515 stores software modules that provide functionality when executed by processor(s) 510. The modules include an operating system 540 for computing system 500. The modules further include a group attack detection module 545 that is configured to detect group attacks using one or more embodiments of the present invention. Computing system 500 may include one or more additional functional modules 550 that include additional functionality.

One skilled in the art will appreciate that a “system” could be embodied as a personal computer, a server, a console, a personal digital assistant (“PDA”), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (“VLSI”) circuits or gate arrays, off-the-shelf semiconductors such as logic chips, transistors, or other discrete electronic components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The method steps performed in FIGS. 2-4 may be performed by a computer program, encoding instructions for the nonlinear adaptive processor to perform at least the methods described in FIGS. 2-4, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the methods described in FIGS. 2-4, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, or an ASIC.

It will be readily understood that the electronic components of various embodiments of the present invention, as generally described and illustrated in the figures herein, may be arranged and designed in a wide variety of different configurations. Thus, the detailed description of the embodiments of the systems, apparatuses, methods, and computer programs of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method, comprising:
determining, by a computing system, an anomaly graph of a network comprising nodes, edges, and an indegree of the nodes in the anomaly graph;
designating, by the computing system, nodes with an indegree of at least two as potential targets;
designating, by the computing system, nodes with no incoming connections as potentially compromised nodes; and
outputting, by the computing system, the designated potentially compromised nodes as potentially associated with a coordinated attack on the network when the potentially compromised nodes connect to at least one of the same potential target nodes.

2. The computer-implemented method of claim 1, wherein the steps of claim 1 are performed periodically, by the computing system, during sliding time windows.

3. The computer-implemented method of claim 1, further comprising:
deleting, by the computing system, incoming edges going to nodes with an indegree of one from the anomaly graph.

4. The computer-implemented method of claim 1, further comprising:
determining, by the computing system, each weakly connected subgraph in the anomaly graph.

5. The computer-implemented method of claim 4, further comprising:
calculating a summary statistic for Oₖ for each subgraph using a number of undirected edges in the given subgraph, the summary statistic determined by:
$${O}_{k} = {\sum }_{i < j}^{ } max \{ I ( {e}_{ij} ∈ {E}_{k} ) , I ( {e}_{ji} ∈ {E}_{k} ) \}$$
where eᵢⱼ and eⱼᵢ represent edges in a set of edges Eₖ for the given subgraph.

6. The computer-implemented method of claim 1, wherein the computing system is configured to treat all of the nodes and edges in the anomaly graph as independent entities.

7. The computer-implemented method of claim 1, wherein for a p-value threshold Tε(0,1), the anomaly graph Sₜ=(Vₜ^{s},Eₜ^{s}) of the network is formed from the edges that have a positive p-value below the threshold:
Eₜ^{s}={(i,j)εEₜ|p_{ij,t}<T}
Vₜ^{s}={iεVₜ|∃j≠iεVₜs.t.(i,j)εEₜ^{s} or (j,i)εEₜ^{s}}
where Eₜ^{s} is a set of edges in Sₜ, Vₜ^{s} is the set of nodes in Sₜ, and p_{ij,t} is the p-value for a given edge (i,j)εEₜ.

8. An apparatus, comprising:
at least one processor; and
memory storing computer program instructions, wherein the instructions, when executed by the at least one processor, are configured to cause the at least one processor to:
monitor a network over time periods to determine anomalous behavior signifying potential activity from a group of attackers during at least one time period; and
provide an indication that a potential group attack is occurring in the network when anomalous behavior is determined during at least one time period.

9. The apparatus of claim 8, wherein the anomalous behavior comprises overlapping or correlated behavior where a group of potentially compromised nodes attempt to connect to common nodes during at least one of the time periods.

10. The apparatus of claim 8, wherein the instructions are further configured to cause the at least one processor to determine a p-value for each edge in the network, where the p-value indicates how far a respective edge has deviated from its normal behavior.

11. The apparatus of claim 10, wherein for a p-value threshold Tε(0,1) the instructions are further configured to cause the at least one processor to form an anomaly graph Sₜ=(Vₜ^{s},Eₜ^{s}) of the network from edges that have a positive p-value below the threshold:
Eₜ^{s}={(i,j)εEₜ|p_{ij,t}<T}
Vₜ^{s}={iεVₜ|∃j≠iεVₜs.t.(i,j)εEₜ^{s} or (j,i)εEₜ^{s}}
where Eₜ^{s} is a set of edges in Sₜ, Vₜ^{s} is the set of nodes in Sₜ, and p_{ij,t} is the p-value for a given edge (i,j)εEₜ.

12. The apparatus of claim 11, wherein the instructions are further configured to cause the at least one processor to:
delete incoming edges going to nodes with an indegree of one from the anomaly graph.

13. The apparatus of claim 11, wherein the instructions are further configured to cause the at least one processor to:
determine each weakly connected subgraph in the anomaly graph.

14. The apparatus of claim 13, wherein the instructions are further configured to cause the at least one processor to calculate a summary statistic for Oₖ for each subgraph using a number of undirected edges in the given subgraph, the summary statistic determined by:
$${O}_{k} = {\sum }_{i < j}^{ } max \{ I ( {e}_{ij} ∈ {E}_{k} ) , I ( {e}_{ji} ∈ {E}_{k} ) \}$$
where eᵢⱼ and eⱼᵢ represent edges in a set of edges Eₖ for the given subgraph.

15. A system, comprising:
memory storing computer program instructions configured to detect anomalies in a network; and
a plurality of processing cores configured to execute the stored computer program instructions, wherein the plurality of processing cores is configured to:
generate an anomaly graph for a network during a time period;
determine whether multiple nodes with no indegree and common node connections exist during the time period; and
generate an indication of a potential group attack on the network when the system determines that multiple nodes with no indegree and common node connections exist in one or more subgraphs of the anomaly graph.

16. The system of claim 15, wherein the indication comprises potentially compromised nodes having no indegree and common node connection, and potential target nodes with an indegree of two or more to which the potentially compromised nodes are connected.

17. The system of claim 15, wherein the plurality of processing cores are further configured to determine a p-value for each edge in the network, where the p-value indicates how far a respective edge has deviated from its normal behavior.

18. The system of claim 17, wherein for a p-value threshold Tε(0,1), the processing cores are further configured to form the anomaly graph Sₜ=(Vₜ^{s},Eₜ^{s}) of the network from edges that have a positive p-value below the threshold:
Eₜ^{s}={(i,j)εEₜ|p_{ij,t}<T}
Vₜ^{s}={iεVₜ|∃j≠iεVₜs.t.(i,j)εEₜ^{s} or (j,i)εEₜ^{s}}
where Eₜ^{s} is a set of edges in Sₜ, Vₜ^{s} is the set of nodes in Sₜ, and p_{ij,t} is the p-value for a given edge (i,j)εEₜ.

19. The system of claim 15, wherein the processing cores are further configured to:
delete incoming edges going to nodes with an indegree of one from the anomaly graph.

20. The system of claim 15, wherein the processing cores are further configured to:
determine each weakly connected subgraph in the anomaly graph.
